(19) United States
(12) Patent Application Publication
(10) Pub. No.: US 2026/0275235 A1
(43) Pub. Date: Sep. 17, 2026

(54) LIQUID DETERGENTS WITH IMPROVED MILDNESS FOR SENSITIVE SKIN AT LOW PH AND METHODS OF MANUFACTURE

(71) Applicant: Henkel AG & Co. KGaA, Duesseldorf (DE)

(72) Inventors: Daniel Thomas Piorkowski, Fairfield, CT (US); Katie Eighmy, Stratford, CT (US)

(73) Assignee: Henkel AG & Co. KGaA, Duesseldorf (DE)

(21) Appl. No.: 19/436,365

(22) Filed: Dec. 30, 2025

Related U.S. Application Data
(60) Provisional application No. 63/773,275, filed on Mar. 17, 2025.

(51) Int. Cl. C11D 1/83; C11D 1/20; C11D 1/29; C11D 3/20; C11D 3/33; C11D 3/37; C11D 17/00

(52) U.S. Cl. CPC C11D 1/83; C11D 1/20; C11D 1/29; C11D 3/2086; C11D 3/33; C11D 3/3746; C11D 17/0008; C11D 2111/12

(57) ABSTRACT

The present disclosure provides a mild detergent composition comprising surfactants at optimized ratios with improved mildness while maintaining cleaning performance. The detergent composition comprises at least one non-ionic surfactant, a first anionic surfactant and a second anionic surfactant, has a pH of about 5 or less, and has a Zein score of not more than about 2% dissolved zein when tested on a 10% dilution.

### BACKGROUND

Laundry detergent compositions contain surfactants which impart good cleaning performance. However, many surfactant compositions can cause skin and eye irritation. Preferred surfactants for efficacy have included the anionic linear alkylbenzene sulfonates (LAS) that can be a harsh additive to detergent compositions, and replacements such as alcohol ethoxysulfonates can contain traces of regulated compounds. Further, solvents included in detergent compositions can be allergens. Propylene glycol was named the 2018 allergen of the year by the American Contact Dermatitis Society.

Consumers generally prefer mild liquid detergent formulations, and several products that claim to be mild are currently on the market. There is a still a need to develop improved mild liquid detergent formulations that have good cleaning performance.

### BRIEF SUMMARY

The present disclosure relates to a detergent composition comprising water, about 15 to about 25 wt % of a surfactant, and optionally, a preservative, wherein the surfactant comprises at least one non-ionic surfactant, a first anionic surfactant and a second anionic surfactant, wherein the non-ionic surfactant and second anionic surfactant are present in an amount ratio of about 1:0 to about 2:1, wherein the composition does not comprise a linear alkyl benzene sulfonate, wherein the detergent composition has a pH of about 5 or less, and wherein the detergent composition has a Zein score of not more than about 2% when tested on a 10% dilution.

In some aspects, the present disclosure relates to a method of manufacturing a liquid detergent composition comprising:
a) creating a base of at least 50 wt % water;
b) adding the at least one non-ionic surfactant and mixing until the non-ionic surfactant is completely solubilized;
c) adding the first anionic surfactant and mixing until the first anionic surfactant is completely solubilized;
d) optionally adding a second anionic surfactant and mixing until the second anionic surfactant is completely solubilized;
e) adding a polymer and mixing until the polymer is completely solubilized;
f) adding a chelant and mixing until the chelant is completely solubilized;
g) reducing the temperature of the mixture obtained from steps a-f to below 30° C.;
h) adding acid and optionally adding a preservative; and
i) adding a remainder of water.

In some aspects, the detergent composition has a Zein score of not more than about 1% when tested on a 10% dilution.

In some aspects, the second anionic surfactant is present in an amount of less than 8 wt %.

In some aspects, the detergent composition further comprises a chelant and a polymer.

In some aspects, the at least one non-ionic surfactant is a non-ionic alcohol ethoxylate.

In some aspects, the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

In some aspects, the first anionic surfactant and the second anionic surfactant are selected from the group consisting of an alkyl ether sulfate, a fatty acid, and combinations thereof. In some aspects, the second anionic surfactant is an alkyl ether sulfate. In some aspects, the first anionic surfactant is palm kernel fatty acid or a coconut fatty acid.

In some aspects, the alkyl ether sulfate is lauryl ether sulfate and the fatty acid is selected from a palm kernel fatty acid, a coconut fatty acid, and combinations thereof.

In some aspects, the detergent composition further comprises at least one additive selected from an acid, an amino acid, a defoamer, a chlorine scavenger, an optical brightener, a fragrance, one or more enzymes, a corrosion inhibitor, and combinations thereof.

In some aspects, the detergent composition further comprises an acid. In some aspects, the acid is citric acid.

In some aspects, the composition is stable for four weeks at each temperature of 4° C., 24° C., 40° C. and 52° C.

In some aspects, the composition comprises water, about 15 to about 25 wt % of a combination of a non-ionic alcohol ethoxylate, a fatty acid, and an alkyl ether sulfate, about 0.5 to about 5 wt % of a combination of an acrylic acid polymer and MGDA, and citric acid.

### DETAILED DESCRIPTION

Provided herein is a detergent composition comprising water, about 15 to about 25 wt % of a surfactant, and optionally, a preservative, wherein the surfactant comprises at least one non-ionic surfactant, a first anionic surfactant and a second anionic surfactant, wherein the non-ionic surfactant and second anionic surfactant are present in an amount ratio of about 1:0 to about 2:1, wherein the composition does not comprise a linear alkyl benzene sulfonate, wherein the detergent composition has a pH of about 5 or less, and wherein the detergent composition has a Zein score of not more than about 2% when tested on a 10% dilution, and methods of manufacturing the same.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little to none of the specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃) CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “Zein score” or “Zein number” as used in the present application refers to a score or number measured using a Zein test (see, e.g., US 2018/0016523), as described in the examples. A Zein test determines the extent of denaturation of Zein corn protein after exposure to a surfactant for a given period of time. Generally, the higher the Zein score, the greater the skin irritation potential.

In some aspects, the detergent compositions described herein have a Zein score of less than about 2% dissolved zein when tested at a 3% dilution. In other aspects the detergent compositions described herein have a Zein score of less than 1% dissolved zein when tested at a 3% dilution. The protocol can also be run on a detergent composition tested at a 10% dilution. In other aspects, the detergent compositions described herein at a 3% dilution (or a 10% dilution) have a Zein score of from about 0.01% to about 2%, from about 0.01% to about 1.75%, about 0.01% to about 1.5%, or about 0.01% to about 1.25%, or about 0.01% to about 1% dissolved zein.

### Detergent Composition

In some aspects, the present disclosure is directed to a liquid detergent composition comprising water, about 15 to about 25 wt % of a surfactant, and optionally, a preservative, wherein the surfactant comprises at least one non-ionic surfactant, a first anionic surfactant and a second anionic surfactant, wherein the non-ionic surfactant and second anionic surfactant are present in an amount ratio of about 1:0 to about 2:1, wherein the composition does not comprise a linear alkyl benzene sulfonate, wherein the detergent composition has a pH of about 5 or less, and wherein the detergent composition has a Zein score of not more than about 2% when tested on a 10% dilution.

Mildness is a significant consumer need and driver for laundry detergent purchase. There are several methods to measure the skin irritancy potential of a surfactant composition, such as the testing methods as described in US 2018/0016523, the entire disclosure of which is incorporated herein by reference. These tests include Zein, Corneosufametry, and Cytokine testing. The aggregate of these scores can be used to determine the mildness of a detergent for consumers.

It was discovered that a mild composition (i.e., a composition with a low Zein score) could be provided with a detergent composition comprising mild surfactants in varying ratios and a low pH. In some aspects, the detergent composition has a Zein score that is not more than 2% dissolved zein when tested on a 10% dilution of the detergent composition when measured in accordance with the method set forth herein and in US 2018/0016523, the disclosure of which is incorporated herein by reference in its entirety. In some aspects, the detergent composition has a Zein score of not more than 2% dissolved zein when tested on a 10% dilution. In some aspects, the detergent composition has a Zein score of not more than 1% dissolved zein when tested on a 10% dilution. In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 10% dilution.

In some aspects, mildness of the detergent composition is controlled by the use of surfactants and pH in varying amounts to improve mildness while maintaining stain removal performance.

In some aspects, the detergent composition comprises water in any amount that is sufficient to bring the total weight of the composition to 100 wt % (q.s.).

It was observed that Zein scores were improved at lower pH ranges. In some aspects, the liquid detergent composition has a pH of below 7. In some aspects, the detergent composition has a pH of below 6.8, below 6.5, below 6.2, below 6, below 5.8, below 5.5, below 5.2, below 5, below 4.8, below 4.5, below 4.2, below 4, below 3.8, or below 3.5. In some aspects, the detergent composition has a pH of below 5.5. In some aspects, the detergent composition has a pH of below 5.

In some aspects, the detergent composition can have a pH of about 2 to about 7 (e.g., about 2.5 to about 6.5, about 3 to about 6, about 3.5 to about 6, about 4 to about 6, about 4.5 to about 6, about 5 to about 6, about 5.5 to about 6, about 2.5 to about 5.8, about 2.5 to about 5.5, about 2.5 to about 5.3, about 2.5 to about 5.2, about 2.5 to about 5, about 3 to about 5.8, about 3 to about 5.5, about 3 to about 5.3, about 3 to about 5, about 3 to about 4.8, about 3 to about 4.5, about 3 to about 4.3, or about 3 to about 4). In some aspects, the detergent composition has a pH of about 6, about 5.5, about 5, about 4.5, about 4, about 3.5, about 3, or about 2.5. In some aspects, the detergent composition has a pH of about 3 to about 6. In some aspects, the detergent composition has a pH of about 5. In some aspects, the detergent composition has a pH of about 4.5. In some aspects, the detergent composition has a pH of about 4. In some aspects, the detergent composition has a pH of about 3.5.

In some aspects, the detergent composition comprises an anionic surfactant, a cationic surfactant, a zwitterionic surfactant, a nonionic surfactant, or a combination thereof. In some aspects, the detergent composition comprises a nonionic surfactant, a first anionic surfactant, and a second anionic surfactant. In some aspects, the detergent composition comprises a surfactant consisting essentially of a nonionic surfactant and a first anionic surfactant.

In some aspects, the first and second anionic surfactants comprise a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt (coconut fatty acid salt or palm kernel fatty acid salt), a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (AES)). Other examples of fatty sulfate include, e.g., 3-sulfopropyl ethoxylate laurylphenyl ether and coco (coconut fatty acid) sulfate. Examples of a fatty acid salt include, e.g. coconut fatty acid, palm kernel fatty acid, oleic acid, lauric acid, palmitic acid, stearic acid, and linoleic acid.

In some aspects, the first anionic surfactant comprises a fatty acid. In some aspects, the first anionic surfactant is a coconut fatty acid. In some aspects, the first anionic surfactant is a palm kernel fatty acid.

In some aspects, the detergent composition comprises from about 0.1 wt % to about 1 wt % of a first anionic surfactant relative to the total weight of the detergent composition. For example, the first anionic surfactant can be from about 0.1 wt % to about 0.9 wt %, about 0.1 wt % to about 0.8 wt %, about 0.1 wt % to about 0.7 wt %, about 0.1 wt % to about 0.6 wt %, about 0.1 wt % to about 0.5 wt %, about 0.1 wt % to about 0.4 wt %, about 0.1 wt % to about 0.3 wt %, about 0.1 wt % to about 0.2 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of the total weight of the detergent composition. In some aspects, the detergent composition comprises from about 0.1 to about 0.3 wt % of a first anionic surfactant (e.g., fatty acid) relative to the total weight of the detergent composition. In some aspects, the detergent composition comprises about 0.2 wt % to about 3 wt % of a first anionic surfactant (e.g., fatty acid). In some aspects, the detergent composition comprises about 0.2 wt % of a first anionic surfactant (e.g., fatty acid).

In some aspects, the second anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate. In some aspects, the AES is sodium laureth sulfate comprising 3 moles of ethoxylate (EO).

In some aspects, the detergent composition comprises from about 0.1 wt % to about 10 wt % of a second anionic surfactant (e.g., an alkyl ether sulfate (AES)) relative to the total weight of the detergent composition. For example, the total anionic surfactant content can be from about 0.1 wt % to about 9.8 wt %, from about 0.1 wt % to about 9.5 wt %, from about 0.1 wt % to about 9 wt %, from about 0.1 wt % to about 8.5 wt %, from about 0.1 wt % to about 8 wt %, from about 0.1 wt % to about 7.8 wt %, from about 0.1 wt % to about 7.6 wt %, from about 0.1 wt % to about 7.4 wt %, from about 0.1 wt % to about 7.2 wt %, from about 0.1 wt % to about 7 wt %, from about 0.1 wt % to about 6.8 wt %, from about 0.1 wt % to about 6.6 wt %, from about 0.1 wt % to about 6.4 wt %, from about 0.1 wt % to about 6.2 wt %, from about 0.1 wt % to about 6 wt %, from about 0.1 wt % to about 5.8 wt %, from about 0.1 wt % to about 5.6 wt %, from about 0.1 wt % to about 5.4 wt %, from about 0.1 wt % to about 5.2 wt %, from about 0.1 wt % to about 5 wt %, from about 0.1 wt % to about 4.8 wt %, from about 0.1 wt % to about 4.6 wt %, from about 0.1 wt % to about 4.4 wt %, from about 0.1 wt % to about 4.2 wt %, from about 0.1 wt % to about 4 wt %, from about 0.1 wt % to about 3.8 wt %, from about 0.1 wt % to about 3.6 wt %, from about 0.1 wt % to about 3.4 wt %, from about 0.1 wt % to about 3.2 wt %, from about 0.1 wt % to about 3 wt %, from about 0.1 wt % to about 2.8 wt %, from about 0.1 wt % to about 2.6 wt %, from about 0.1 wt % to about 2.4 wt %, from about 0.1 wt % to about 2.2 wt %, from about 0.1 wt % to about 1 wt %, from about 0.1 wt % to about 0.8 wt %, from about 0.1 wt % to about 0.6 wt %, from about 0.1 wt % to about 0.4 wt %, from about 0.1 wt % to about 0.2 wt %, about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %, of the total weight of the detergent composition. In some aspects, the detergent composition comprises about 1 to about 4 wt % of a second anionic surfactant (e.g., an alkyl ether sulfate (AES)). In some aspects, the alkyl ether sulfate (AES) is present in an amount of about 3 wt % to about 9 wt %. In some aspects, the alkyl ether sulfate (AES) is present in an amount of about 8 wt %. In some aspects, the alkyl ether sulfate (AES) is present in an amount of about 3.5 wt %.

In some aspects, the detergent composition does not comprise or is substantially free of a linear alkylbenzene sulfonate (LAS). LAS has the structure of Formula (I).

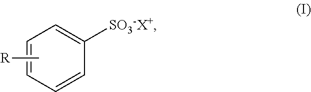

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the detergent compositions comprises a first anionic surfactant and a second anionic surfactant. In some aspects, the first anionic surfactant and the second anionic surfactant are selected from the group consisting of an alkyl ether sulfate, a fatty acid, and combinations thereof. In some aspects, the first anionic surfactant comprises a fatty acid selected from a palm kernel fatty acid and a coconut fatty acid. In some aspects, the first anionic surfactant is a coconut fatty acid and the second anionic surfactant is an alkyl ether sulfate (AES). In some aspects, the first anionic surfactant is a palm kernel fatty acid and the second anionic surfactant is an alkyl ether sulfate (AES).

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate.

In general, the alcohol ethoxylate (AE) will have a chemical structure of formula (I):

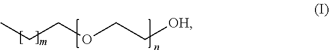

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol.

In some aspects, the detergent composition comprises from about 10 wt % to about 20 wt % of a nonionic surfactant (e.g., an alcohol ethoxylate (AE)), relative to the total weight of the detergent composition. For example, the total non-ionic surfactant content can be from about 10 wt % to about 19 wt %, about 10 wt % to about 18 wt %, about 10 wt % to about 17 wt %, about 10 wt % to about 16 wt %, about 10 wt % to about 15 wt %, about 10 wt % to about 14 wt %, about 10 wt % to about 13 wt %, about 10 wt % to about 12 wt %, about 10 wt % to about 11 wt %, about 11 wt % to about 20 wt % about 11 wt % to about 19 wt %, about 11 wt % to about 18 wt %, about 11 wt % to about 17 wt %, about 11 wt % to about 16 wt %, about 11 wt % to about 15 wt %, about 11 wt % to about 14 wt %, about 11 wt % to about 13 wt %, about 11 wt % to about 12 wt %, about 12 wt % to about 20 wt % about 12 wt % to about 19 wt %, about 12 wt % to about 18 wt %, about 12 wt % to about 17 wt %, about 12 wt % to about 16 wt %, about 12 wt % to about 15 wt %, about 12 wt % to about 14 wt %, about 12 wt % to about 13 wt %, about 20 wt %, about 19 wt %, about 18 wt %, about 17 wt %, about 16 wt %, about 15 wt %, about 14 wt %, about 13 wt %, about 12 wt %, about 11 wt % or about 10 wt %, of the total weight of the detergent composition. In some aspects, the detergent composition comprises about 10 to about 20 wt % of a non-ionic surfactant. In some aspects, the detergent composition comprises about 10 to about 17.5 wt % of a non-ionic surfactant (e.g., a non-ionic alcohol ethoxylate (AE)).

In some aspects, the detergent composition comprises an alcohol ethoxylate (AE), a coconut fatty acid, and an alkyl ether sulfate (AES). In some aspects, the detergent composition comprises an alcohol ethoxylate (AE), a palm kernel fatty acid, and an alkyl ether sulfate (AES) In some aspects, the detergent composition comprises an alcohol ethoxylate (AE), a fatty acid, an alkyl ether sulfate (AES), and does not comprise (e.g., is substantially free of) a linear alkylbenzene sulfonate.

In some aspects, the detergent composition comprises about 10 to about 30 wt % of a surfactant, wherein the surfactant comprises at least one non-ionic surfactant, a first anionic surfactant and a second anionic surfactant. In some aspects, the detergent composition comprises about 10 wt % to about 28 wt %, about 10 wt % to about 26 wt %, about 10 wt % to about 24 wt %, about 10 wt % to about 22 wt %, about 10 wt % to about 20 wt %, about 10 wt % to about 18 wt %, about 10 wt % to about 16 wt %, about 10 wt % to about 14 wt %, about 10 wt % to about 12 wt %, about 10 wt %, about 12 wt %, about 14 wt %, about 16 wt %, about 18 wt %, about 20 wt %, about 22 wt %, about 24 wt %, about 26 wt %, about 28 wt %, or about 30 wt %, of a surfactant, wherein the surfactant comprises at least one non-ionic surfactant, a first anionic surfactant and a second anionic surfactant. In some aspects, the detergent composition comprises about 15 to about 25 wt % of a surfactant, wherein the surfactant comprises at least one non-ionic surfactant, a first anionic surfactant and a second anionic surfactant. In some aspects, the detergent composition comprises about 15 to about 25 wt % of a non-ionic alcohol ethoxylate, a fatty acid, and an alkyl ether sulfate. In some aspects, the non-ionic surfactant and second anionic surfactant are present in an amount ratio of about 1:0 to about 2:1. In some aspects, the non-ionic surfactant and second anionic surfactant are present in an amount ratio of about 1:0. In some aspects, the non-ionic surfactant and second anionic surfactant are present in an amount ratio of about 1:1. In some aspects, the non-ionic surfactant and second anionic surfactant are present in an amount ratio of about 2:1.

In some aspects, the detergent composition comprises a chelating agent (i.e., a chelant) that serves to improve the cleaning action of the detergent by scavenging metal ions naturally found in water. Suitable examples of a chelating agent includes, e.g., methylglycindiacetic acid (MGDA), citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, ethylenediamine-N,N′-disuccinic acid (EDDS), glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate (IDS)), or any combination thereof. In some aspects, the detergent composition comprises methylglycindiacetic acid (MGDA).

In some aspects, the detergent composition comprises from about 0.1 wt % to about 3 wt % of a chelating agent relative to the total weight of the detergent composition. For example, the chelating agent can be present in an amount from about 0.1 wt % to about 3 wt %, about 0.1 wt % to about 2.8 wt %, about 0.1 wt % to about 2.6 wt %, about 0.1 wt % to about 2.6 wt %, about 0.1 wt % to about 2.4 wt %, about 0.1 wt % to about 2.2 wt %, about 0.1 wt % to about 2 wt %, about 0.1 wt % to about 1.9 wt %, about 0.1 wt % to about 1.8 wt %, about 0.1 wt % to about 1.7 wt %, about 0.1 wt % to about 1.6 wt %, about 0.1 wt % to about 1.5 wt %, about 0.1 wt % to about 1.4 wt %, about 0.1 wt % to about 1.3 wt %, about 0.1 wt % to about 1.2 wt %, about 0.1 wt % to about 1.1 wt %, from about 0.1 wt % to about 1 wt %, about 0.1 wt % to about 0.9 wt %, about 0.1 wt % to about 0.8 wt %, about 0.1 wt % to about 0.7 wt %, about 0.1 wt % to about 0.6 wt %, about 0.1 wt % to about 0.5 wt %, about 0.1 wt % to about 0.4 wt %, about 0.1 wt % to about 0.3 wt %, about 0.1 wt % to about 0.2 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, or about 2.9 wt %, of the total weight of the detergent composition. In some aspects, the detergent composition comprises from about 0.5 wt % to about 1 wt % of a chelating agent (e.g., methylglycindiacetic acid (MGDA)). In some aspects, the detergent composition comprises from about 2 wt % to about 3 wt % of a chelating agent (e.g., methylglycindiacetic acid (MGDA)).

In some aspects, the detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the detergent composition comprises from about 0.1 wt % to about 3 wt % of an anti-redeposition agent relative to the total weight of the detergent composition. For example, the anti-redeposition agent can be present in an amount from about about 0.1 wt % to about 3 wt %, about 0.1 wt % to about 2.8 wt %, about 0.1 wt % to about 2.6 wt %, about 0.1 wt % to about 2.6 wt %, about 0.1 wt % to about 2.4 wt %, about 0.1 wt % to about 2.2 wt %, about 0.1 wt % to about 2 wt %, about 0.1 wt % to about 1.9 wt %, about 0.1 wt % to about 1.8 wt %, about 0.1 wt % to about 1.7 wt %, about 0.1 wt % to about 1.6 wt %, about 0.1 wt % to about 1.5 wt %, about 0.1 wt % to about 1.4 wt %, about 0.1 wt % to about 1.3 wt %, about 0.1 wt % to about 1.2 wt %, about 0.1 wt % to about 1.1 wt %, from about 0.1 wt % to about 1 wt %, about 0.1 wt % to about 0.9 wt %, about 0.1 wt % to about 0.8 wt %, about 0.1 wt % to about 0.7 wt %, about 0.1 wt % to about 0.6 wt %, about 0.1 wt % to about 0.5 wt %, about 0.1 wt % to about 0.4 wt %, about 0.1 wt % to about 0.3 wt %, about 0.1 wt % to about 0.2 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, or about 2.9 wt %, of the total weight of the detergent composition. In some aspects, the detergent composition comprises from about 0.1 wt % to about 1 wt % of an anti-redeposition polymer (e.g., homopolymer of acrylic acid). In some aspects, the detergent composition comprises about 0.5 wt % of an anti-redeposition polymer (e.g., homopolymer of acrylic acid).

In some aspects, the detergent composition comprises a polymer and chelant. In some aspects, the detergent composition comprises a combination of a polymer and a chelant in an amount of about 0.5 wt % to about 5 wt %. In some aspects, the detergent composition comprises about 0.5 wt % to about 5 wt % of a combination of an acrylic acid polymer and methylglycindiacetic acid (MGDA).

In some aspects, the detergent composition comprises a preservative or biocide, which is any suitable compound with antimicrobial (e.g., antibacterial, antiviral, antifungal) activity. Examples of a preservative that can be contained in the detergent composition include, sodium benzoate, dichloroisocyanuric acid, hydrogen peroxide, a quaternary ammonium compound, glutaraldehyde, tetrakis (hydroxymethyl)phosphonium sulfate (THPS), 2,2-dibromo-3-nitrilopropionamide (DBNPA), 2,2-dibromo-3-nitrilpropionamide, 2-(hydroxymethylamino)-ethanol, 2-bromo-2-nitropropane-1,3-diol, β-bromo-β-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorthalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, and any combination thereof. In some aspects, the preservative can be sodium benzoate.

In some aspects, the detergent composition comprises from about 0.001 wt % to about 1 wt % of a preservative relative to the total weight of the detergent composition. For example, the preservative can be present in an amount from about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.6 wt %, about 0.001 wt % to about 0.5 wt %, about 0.001 wt % to about 0.4 wt %, about 0.001 wt % to about 0.3 wt %, about 0.001 wt % to about 0.2 wt %, about 0.001 wt % to about 0.1 wt %, about 0.001 wt % to about 0.09 wt %, about 0.001 wt % to about 0.08 wt %, about 0.001 wt % to about 0.07 wt %, about 0.001 wt % to about 0.06 wt %, about 0.001 wt % to about 0.05 wt %, about 0.001 wt % to about 0.04 wt %, about 0.001 wt % to about 0.03 wt %, about 0.001 wt % to about 0.02 wt %, about 0.001 wt % to about 0.01 wt %, about 0.001 wt % to about 0.009 wt %, about 0.001 wt % to about 0.008 wt %, about 0.001 wt % to about 0.007 wt %, about 0.001 wt % to about 0.006 wt %, about 0.001 wt % to about 0.005 wt %, about 0.001 wt % to about 0.004 wt %, about 0.001 wt % to about 0.003 wt %, or about 0.001 wt % to about 0.002 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises from about 0.1 wt % to about 0.5 wt % of a preservative. In some aspects, the detergent composition comprises from about 0.15 wt % of a preservative. In some aspects, the detergent composition comprises from about 0.4 wt % of a preservative.

As commercial consumer products, liquid detergent formulations are usually stored and used over a period of time, and their appearance and cleaning properties should remain stable for at least their shelf life. Instabilities of a liquid detergent composition can include visible changes such as phase separation, particulate formation, crystallization, discoloration, as well as chemical changes that result in diminished cleaning performance.

In some aspects, the detergent composition is stable at freezing temperatures for a period of about 1 week to about 4 weeks. For example, the detergent composition is stable at 0° C. for a period of about 1 week, about 2 weeks, about 3 weeks, or about 4 weeks. In some aspects, the detergent composition is stable at a temperature of 4° C. for a period of about 1 week to about 4 weeks. For example, the detergent composition is stable at 4° C. for a period of about 1 week, about 2 weeks, about 3 weeks, or about 4 weeks. In some aspects, the detergent composition is stable at a temperature of 24° C. for a period of about 1 week to about 4 weeks. For example, the detergent composition is stable at 24° C. for a period of about 1 week, about 2 weeks, about 3 weeks, or about 4 weeks. In some aspects, the detergent composition is stable at a temperature of 40° C. for a period of about 1 week to about 4 weeks. For example, the detergent composition is stable at 40° C. for a period of about 1 week, about 2 weeks, about 3 weeks, or about 4 weeks. In some aspects, the detergent composition is stable at a temperature of 52° C. for a period of about 1 week to about 4 weeks. For example, the detergent composition is stable at 52° C. for a period of about 1 week, about 2 weeks, about 3 weeks, or about 4 weeks. In some aspects, the detergent composition is stable at a temperature of 0° C. for at least 4 weeks. In some aspects, the detergent composition is stable at a temperature of 4° C. for at least 4 weeks. In some aspects, the detergent composition is stable at a temperature of 24° C. for at least 4 weeks. In some aspects, the detergent composition is stable at a temperature of 40° C. for a period of at least 4 weeks. In some aspects, the detergent composition is stable at a temperature of 52° C. for a period of at least 4 weeks.

In some aspects, the detergent composition further comprises at least one additive. For example, the at least one additive can be selected from an acid, a base, an amino acid, a performance polymer, a defoamer, a chlorine scavenger, an optical brightener, a fragrance, one or more enzymes, a corrosion inhibitor, and any combination thereof.

In some aspects, the detergent composition comprises from about 1 wt % to about 20 wt % of a total amount of additives relative to the total weight of the detergent composition. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % of the total weight of the detergent composition.

To help maintain the pH, in some aspects, the liquid detergent composition can further comprise an acid, which is any suitable compound with a pKa of less than about 10. In some aspects, the acid is an inorganic acid or an organic acid. In some aspects, the acid is a weak acid such that the acid has a pKa of 2 or greater (e.g., pKa is about 2 to about 10). Examples of a weak acid include, e.g., an organic acid or carbonic acid In some aspects, the acid in the opaque liquid detergent composition is an organic acid, which in some instances can additionally act as a chelating agent. The organic acid can contain one or more (e.g., 1, 2, or 3) carboxylic acid groups, which can be used singly or in combination. In some aspects, the acid in the detergent composition is citric acid. In some aspects, the acid can be an acid solution (e.g., an acid in water).

In some aspects, the liquid detergent composition comprises from about 0.1 wt % to about 10 wt % of acid (e.g., an organic acid, such as citric acid) relative to the total weight of the detergent composition. For example, the acid can be present in an amount of about 0.1 wt % to about 5 wt %, about 0.1 wt % to about 3 wt %, about 0.1 wt % to about 2 wt %, about 0.1 wt % to about 1 wt %, about 0.1 wt % to about 0.8 wt %, about 0.1 wt % to about 0.6 wt %, about 0.1 wt % to about 0.4 wt %, about 0.1 wt % to about 0.3 wt %, about 0.2 wt % to about 10 wt %, about 0.2 wt % to about 5 wt %, about 0.2 wt % to about 3 wt %, about 0.2 wt % to about 2 wt %, about 0.2 wt % to about 1 wt %, about 0.2 wt % to about 0.8 wt %, about 0.2 wt % to about 0.6 wt %, about 0.2 wt % to about 0.4 wt %, about 0.2 wt % to about 0.3 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1 wt %, about 0.5 wt % to about 0.8 wt %, about 0.5 wt % to about 0.6 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.15 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 0.1 wt % to about 1 wt %, or about 0.2 wt % to about 0.5 wt % of an organic acid (e.g., citric acid). In some aspects, the detergent composition comprises about 0.1 wt % to about 5 wt % of citric acid. In some aspects, the detergent composition comprises about 1 wt % to about 4 wt % of citric acid.

In some aspects, the detergent composition comprises a base to adjust the pH. The base can be any suitable compound with a pKb of about 0.1 to about 13. In some aspects, the base can be monoethanolamine, diethanolamine, triethanolamine, methyl diethanolamine, a hydroxide, a tetraborate, a phosphate, a carbonate, a bicarbonate, or any combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the base can be a base solution (e.g., a base in water). In some aspects, the detergent composition comprises a carbonate. In some aspects, the base in the detergent composition is sodium hydroxide. In some aspects, the base is a base solution (e.g., a 50% or 70% sodium hydroxide solution). In some aspects, the detergent composition comprises a base in any amount sufficient (q.s.) to achieve the desired pH.

In some aspects, the detergent composition comprises an acid and a base to form a buffer. The buffer can be any suitable composition that is water soluble and controls (i.e., maintains) the pH of the detergent composition within a pH of about 5 to about 7.7 (e.g., maintains a pH of about 5, about 5.5, about 6, about 6.5, about 7, about 7.5, or about 7.7). In some embodiments, the pH can be controlled to be within a range of about 6 to about 7.1 or a pH of about 7. In general, the buffer can comprise a weak acid and its conjugate base, a strong acid and a weak base, or a strong base and a weak acid. Examples of suitable acids and bases are described herein. In general, a strong acid will have a pKa of less than 2 and a weak acid will have a pKa of 2 or greater. In general, a strong base will have a pKb of less than 2 and a weak base will have a pKb of 2 or greater. For example, the buffer can comprise sodium hydroxide in combination with a weak acid, such as citric acid.

In some aspects, the detergent composition comprises a performance polymer that improves at least one aspect of a washed textile. In some aspects, the performance polymer improves the cleaning action of the detergent composition, removes or reduces stains, maintains whiteness, protects color, protects the integrity of a textile, provides odor control, or any combination thereof.

In some aspects, the detergent composition comprises a defoamer that helps maintain the rise of foam, which can, in some aspects, avoid high foaming or water spilling from a washing machine. In general, the defoamer has a low viscosity.

In some aspects, the detergent composition comprises an enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats.

In some aspects, the detergent composition comprises a chlorine scavenger. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor.

In some aspects, the detergent composition comprises an optical brightener (e.g., a fluorescent whitening agent), which is any suitable hydrophilic compound that absorbs ultra violet light and emits visible (e.g., blue-violet) light to make textiles appear brighter.

In some aspects, the detergent composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting.

In some aspects, the detergent composition comprises an acid, a base, at least one performance polymer, a fragrance, and an enzyme. In some aspects, the detergent composition comprises sodium hydroxide, citric acid, and a fragrance as additives. In some aspects, the detergent composition comprises an acid, a base, at least one enzyme, and a fragrance as additives.

In some aspects, the detergent composition comprises water, surfactant, and optionally, a preservative, wherein the surfactant comprises at least one non-ionic surfactant, a first anionic surfactant and a second anionic surfactant, wherein the detergent composition has a pH of about 5 or less, and wherein the detergent composition has a Zein score of not more than about 2% when tested on a 10% dilution.

In some aspects, the detergent composition comprises water, about 10 wt % to about 30 wt % of a surfactant, and optionally, a preservative, wherein the surfactant comprises at least one non-ionic surfactant, a first anionic surfactant and a second anionic surfactant, wherein the detergent composition has a pH of about 5 or less, and wherein the detergent composition has a Zein score of not more than about 2% when tested on a 10% dilution.

In some aspects, the detergent composition comprises water, about 15 wt % to about 25 wt % of a surfactant, and optionally, a preservative, wherein the surfactant comprises at least one non-ionic surfactant, a first anionic surfactant and a second anionic surfactant, wherein the detergent composition has a pH of about 5 or less, and wherein the detergent composition has a Zein score of not more than about 2% when tested on a 10% dilution.

In some aspects, the detergent composition comprises water, about 15 wt % to about 25 wt % of a combination of a non-ionic alcohol ethoxylate, a fatty acid, and an alkyl ether sulfate, about 0.5 to about 2 wt % of a combination of an acrylic acid polymer and MGDA, citric acid, and optionally, a preservative, wherein the surfactant comprises at least one non-ionic surfactant, a first anionic surfactant and a second anionic surfactant, wherein the non-ionic surfactant and second anionic surfactant are present in an amount ratio of about 1:0 to about 2:1, wherein the composition does not comprise a linear alkyl benzene sulfonate, wherein the detergent composition has a pH of about 5 or less, and wherein the detergent composition has a Zein score of not more than about 2% when tested on a 10% dilution.

In some aspects, the detergent composition comprises water, about 15 wt % to about 25 wt % a combination of a non-ionic alcohol ethoxylate, a fatty acid, and an alkyl ether sulfate, about 0.5 to about 2 wt % of a combination of an acrylic acid polymer and MGDA, citric acid, and optionally, a preservative, the non-ionic surfactant and second anionic surfactant are present in an amount ratio of about 1:0 to about 2:1, wherein the composition does not comprise a linear alkyl benzene sulfonate, wherein the detergent composition has a pH of about 4.5 or less, and wherein the detergent composition has a Zein score of not more than about 1% when tested on a 10% dilution.

In some aspects, the detergent composition is a liquid, including a liquid that is dispensed from a container upon use.

In some aspects, the present disclosure is directed to a method of using the detergent composition of any of the foregoing aspects. For example, the detergent composition can be used in a method of removing soil from a textile (e.g., cleaning a textile, such as a fabric). In particular, the present disclosure is directed to a method of removing soil from a textile comprising contacting the textile with a composition comprising the detergent composition described herein and water to form a washing load. Optional steps include mixing (e.g., agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and any combination thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 10-20° C., about 12-16° C., or about 15° C.).

In an aspect, the method is directed to providing a mild detergent composition.

In an aspect, the method is directed to providing an allergen-free detergent composition.

In an aspect, the method is directed to providing detergent compositions comprising Safer Choice ingredients.

It was discovered that the order of addition in manufacturing the liquid detergent composition influenced the physical appearance and stability of the composition.

It was discovered that the following order of addition maximizes the low pH detergent composition's stability: 1) water base; 2) non-ionic surfactant; 3) fatty acid anionic surfactant; 4)alkyl ether sulfate anionic surfactant, if present; 5) polymer; 6) chelant; 7) acid; and optionally, 8) preservative. In particular, the when the alkyl ether sulfate is added prior to the fatty acid, a haze is observed in the composition, which can be neutralized with sufficient base. In detergent compositions with low pH however, there is no base present to neutralize these precipitates and thus the order of addition is significant to the detergent composition's final physical appearance and stability.

Accordingly, the present disclosure is directed to a method of manufacturing the liquid detergent composition described herein. In some aspects, the present disclosure relates to a method of manufacturing a liquid detergent composition comprising:
a) creating a base of at least 50 wt % water;
b) adding the at least one non-ionic surfactant and mixing until the non-ionic surfactant is completely solubilized;
c) adding the first anionic surfactant and mixing until the first anionic surfactant is completely solubilized;
d) optionally adding a second anionic surfactant and mixing until the second anionic surfactant is completely solubilized;
e) adding a polymer and mixing until the polymer is completely solubilized;
f) adding a chelant and mixing until the chelant is completely solubilized;
g) reducing the temperature of the mixture obtained from steps a-f to below 30° C.;
h) adding acid and optionally adding a preservative; and
i) adding a remainder of water.

### Examples

These examples are provided for the purpose of illustration only and the embodiments described herein should in no way be construed as being limited to these examples. Rather, the embodiments should be construed to encompass any and all variations which become evident as a result of the teaching provided herein.

### Example 1 (Mildness)

A base detergent composition (Base Formulation 1) was prepared with the components listed in Table 1. Formulation 1 was post dosed with citric acid or sodium hydroxide to match a target pH ranging from 5 to 11.4. The resulting detergent compositions (Formulations 1A-H) were then evaluated for Zein. The resulting Zein scores are shown below in Table 2.

TABLE 1
Base Formulation 1

| Material | % |
|---|---|
| Water | QS to 100 |
| Alcohol Ethoxylate | 11.28 |
| SLES, 3 EO (70% active) | 8.06 |
| Fatty Acid | 0.23 |
| Carbonate, Polymer, MGDA, and Presevative | 2.8 |

SLES: sodium lauryl ether sulfate
EO: ethoxylate
MGDA: methylglycinediacetic acid

TABLE 2

| Formula | pH | Zein Avg. |
|---|---|---|
| 1A | 11.4 | 1.57 |
| 1B | 11 | 1.57 |
| 1C | 10 | 1.43 |
| 1D | 9 | 1.26 |
| 1E | 8 | 1.12 |
| 1F | 7 | 0.98 |
| 1G | 6 | 0.83 |
| 1H | 5 | 0.65 |

The resulting Zein scores show that the detergent composition demonstrated improved Zein scores as pH was lowered.

### Example 2 (Cleaning Performance)

A high pH control Formulation was prepared using the base formulation shown in Table 3 (Control Formulation). A base detergent composition (Low pH Base Formulation 2) was prepared with the components listed in Table 4. Formulation 2 was post dosed with citric acid or sodium hydroxide to match a target pH ranging from 3.5 to 5. The four resulting detergent compositions (Formulations 2A-D) were then evaluated for cleaning performance on ten target stains (10 stains on 2 different fabric types (Knitted Cotton and Polyester) for a total of 20 comparisons). The resulting cleaning performance scores are shown below in Table 6.

TABLE 3
Control Formulation

| Material | % |
|---|---|
| Water | QS to 100 |
| Alcohol Ethoxylate | 14.29 |
| SLES, 3 EO (70% active) | 3.57 |
| Sodium Hydroxide | 0.03 |
| Fatty Acid | 0.23 |
| Carbonate, Polymer, MGDA, and Preservative | 3.64 |

SLES: sodium lauryl ether sulfate
EO: ethoxylate
MGDA: methylglycinediacetic acid

TABLE 4
Low pH Base Formulation 2

| Material | % |
|---|---|
| Water | QS to 100 |
| Alcohol Ethoxylate | 14.29 |
| SLES, 3 EO (70% active) | 3.57 |
| Fatty Acid | 0.23 |
| Polymer, MGDA and Preservative | 3.59 |

SLES: sodium lauryl ether sulfate
EO: ethoxylate
MGDA: methylglycinediacetic acid

TABLE 5
Cleaning Performance Scores vs. Control Formulation

| Formulation | pH | Wins | Losses | Net (Wins/Losses) |
|---|---|---|---|---|
| 2A | 3.5 | 4 | 0 | 4 |
| 2B | 4 | 3 | 0 | 3 |
| 2C | 4.5 | 2 | 2 | 0 |
| 2D | 5 | 1 | 1 | 0 |

Based on the stain performance data in Table 5, parity was observed for all lower pH formulas (Formulations 2A-D) vs. the high pH composition (Control Formulation). Notably, Formulations 2A-B, with a pH of 4 or less, demonstrated an overall better cleaning performance compared to the high pH Control Formulation.

### Example 3 (Stability)

The stability impact of varying surfactant ratios at a low pH was examined. Two master batches, Full SLES and Full Non-ionic were prepared using the components listed in Tables 6 and 7, respectively. Blends of each master batch were made with SLES reductions of 50%, 75%, and 100%, and post dosed with citric acid to achieve a target pH of 4.5, (Formulations 3A-C). A brand name formulation (Formulation 3D), with a pH of 11.1, was also prepared for comparison. The resulting formulations (3A-D) are shown below in Table 8.

TABLE 6
Full SLES

| | Active | Weight |
|---|---|---|
| Material | (%) | (%) |
| Water | 100 | QS to 100 |
| Alcohol Ethoxylate | 100 | 11.6 |
| SLES, 3 EO | 70 | 8.29 |
| Fatty Acid | 100 | 0.23 |
| Polymer and MGDA | 45, 40 | 1.45 |
| Preservative | 100 | 0.4 |

SLES: sodium lauryl ether sulfate
EO: ethoxylate
MGDA: methylglycinediacetic acid

TABLE 7
Full Non-ionic (NI)

| | Active | Weight |
|---|---|---|
| Material | (%) | (%) |
| Water | 100 | QS to 100 |
| Alcohol Ethoxylate | 100 | 17.4 |
| SLES, 3 EO | 70 | 0 |
| Fatty Acid | 100 | 0.23 |
| Polymer and MGDA | 45, 40 | 1.45 |
| Preservative | 100 | 0.4 |

SLES: sodium lauryl ether sulfate
EO: ethoxylate
MGDA: methylglycinediacetic acid

TABLE 8
Formulations 3A-D

| | Blend | | NI | SLES | Active | SLES |
|---|---|---|---|---|---|---|
| | Ratio | | (% | (% | Surfactant | Reduction |
| Formula | (SLES:NI) | pH | active) | active) | (%) | (%) |
| 3A | 1:1 | 4.5 | 14.5 | 2.9 | 17.4% | 50% |
| 3B | 1:2 | 4.5 | 15.47 | 1.93 | 17.4% | 75% |
| 3C | 0:1 | 4.5 | 17.4 | 0 | 17.4% | 100% |
| 3D | (Control) | 11.1 | 14.291 | 2.501 | 16.79% | 0 |

NI: nonionic surfactant
SLES: sodium lauryl ether sulfate, 3EO (70% active)
MGDA: methylglycinediacetic acid

Formulations 3A-D were then tested for stability by placing 100 grams of each formulation into a jar for a total period of 4 weeks at 0° C., 4° C., 24° C., 40° C., and 52° C. The compositions were assessed visually for discoloration, phase separation or precipitation of the formulations. As shown in Table 9, Formulations 3A and 3C were stable at each measured time point. Formulation 3B showed phase separation at 0° C., 4° C., and 52° C. at all measured time points.

TABLE 9
Stability

| | | | | | |
|---|---|---|---|---|---|
| Formulation | 0 C. | 4 C. | 24 C. | 40 C. | 52 C. |

Week 1

| | | | | | |
|---|---|---|---|---|---|
| 3A | PASS | PASS | PASS | PASS | PASS |
| 3B | Phase | Phase | PASS | PASS | Phase |
| | Separation | Separation | | | Separation |
| 3C | PASS | PASS | PASS | PASS | PASS |
| 3D (Comparative) | PASS | PASS | PASS | PASS | PASS |

Week 2

| | | | | | |
|---|---|---|---|---|---|
| 3A | PASS | PASS | PASS | PASS | PASS |
| 3B | Phase | Phase | PASS | PASS | Phase |
| | Separation | Separation | | | Separation |
| 3C | PASS | PASS | PASS | PASS | PASS |
| 3D (Comparative) | PASS | PASS | PASS | PASS | PASS |

Week 4

| | | | | | |
|---|---|---|---|---|---|
| 3A | PASS | PASS | PASS | PASS | PASS |
| 3B | Phase | Phase | PASS | PASS | Phase |
| | Separation | Separation | | | Separation |
| 3C | PASS | PASS | PASS | PASS | PASS |
| 3D (Comparative) | PASS | PASS | PASS | PASS | PASS |

### Example 4 (SLES and Zein Data)

Two master batches, Full SLES and Full Non-ionic were prepared using the components listed in Tables 10 and 11, respectively. Blends of each master batch were made with varying ratios of SLES and non-ionic surfactant, and post dosed with citric acid to achieve a target pH of 4.5, resulting in Formulations 4A-E. The resulting detergent compositions (Formulations 4A-E) were then evaluated for Zein. The resulting Zein scores are shown below in Table 12.

TABLE 10
Full SLES

| | Active | Weight |
|---|---|---|
| Material | (%) | (%) |
| Water | 100 | QS to 100 |
| Alcohol Ethoxylate | 100 | 11.6 |
| SLES, 3 EO | 70 | 8.29 |
| Fatty Acid | 100 | 0.23 |
| Polymer and MGDA | 45, 40 | 1.45 |

SLES: sodium lauryl ether sulfate
EO: ethoxylate
MGDA: methylglycinediacetic acid

TABLE 11
Full Non-ionic (NI)

| | Active | Weight |
|---|---|---|
| Material | (%) | (%) |
| Water | 100 | QS to 100 |
| Alcohol Ethoxylate | 100 | 17.4 |
| SLES, 3 EO | 70 | 0 |
| Fatty Acid | 100 | 0.23 |
| Polymer and MGDA | 45, 40 | 1.45 |

SLES: sodium lauryl ether sulfate
EO: ethoxylate
MGDA: methylglycinediacetic acid

TABLE 12
Formulations 4A-E Zein Scores

| | | | | | Total | Zein % |
|---|---|---|---|---|---|---|
| | | | NI | SLES | Active | (average |
| | | Blend | (% | (% | Surfactant | of two |
| Formula | pH | Ratio | active) | active) | (%) | replicates) |
| 4A | 4.5 | 100% SLES | 11.6 | 5.8 | 17.4% | 0.42 |
| 4B | 4.5 | 2:1 | 13.5 | 3.87 | 17.4% | .32 |
| | | SLES:NI | | | | |
| 4C | 4.5 | 1:1 | 14.5 | 2.9 | 17.4% | .21 |
| | | SLES:NI | | | | |
| 4D | 4.5 | 1:2 | 15.47 | 1.93 | 17.4% | .19 |
| | | SLES:NI | | | | |
| 4E | 4.5 | 100% NI | 17.4 | 0 | 17.4 | .42 |

NI: nonionic surfactant
SLES: sodium lauryl ether sulfate

The Zein results shown in Table 12, demonstrate a parabolic relationship of SLES and mildness (Zein score). This differs from previous high pH studies, suggesting a preferred ratio of about 1:2 SLES to non-ionic surfactant at a low pH to optimize mildness and cleaning performance.

### Example 5 (Order of Addition)

In previous high pH formulations, the order of addition for surfactants was as follows: 1) alcohol ethoxylate, 2) sodium laureth sulfate, then 3) fatty acid. Upon addition of fatty acid, a haze or flecks throughout the solution can be seen. These flecks subside when neutralized with sufficient base (NaOH/sodium carbonate).

In a low pH formula, however, no base is added. Order of addition modifications were made to stabilize the formula. Experiments were conducted that showed that the instability only occurred when the sodium laureth sulfate had already solubilized with the alcohol ethoxylate. Fatty acid is not soluble in water; in order to solubilize, the fatty acid must form mixed micelles with another surfactant, in this case, alcohol ethoxylate.

The order of addition was modified to 1) alcohol ethoxylate, 2) fatty acid, then 3) sodium laureth sulfate. This allows the fatty acid to form mixed micelles that are stable in solution. Sodium laureth sulfate can then be added and not impact the mixed micelle of alcohol ethoxylate and fatty acid.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A liquid detergent composition comprising
i. water;
ii. about 15 to about 25 wt % of surfactant; and
iii. optionally a preservative,
wherein the surfactant comprises at least one non-ionic surfactant, a first anionic surfactant and a second anionic surfactant, wherein the non-ionic surfactant and second anionic surfactant are present in an amount ratio of about 1:0 to about 2:1,
wherein the composition does not comprise a linear alkyl benzene sulfonate,
wherein the detergent composition has a pH of about 5 or less, and
wherein the detergent composition has a Zein score of less than 2% when tested on a 10% dilution.

2. The detergent composition of claim 1, wherein the detergent composition has a Zein score of less than 1% when tested on a 10% dilution.

3. The detergent composition of claim 1, wherein the second anionic surfactant is present in an amount of less than 8 wt %.

4. The detergent composition of claim 1, wherein the detergent composition further comprises a chelant and a polymer.

5. The detergent composition of claim 1, wherein the at least one non-ionic surfactant is a non-ionic alcohol ethoxylate.

6. The detergent composition of claim 5, wherein the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

7. The detergent composition of claim 1, wherein the first anionic surfactant and the second anionic surfactant are selected from the group consisting of an alkyl ether sulfate, a fatty acid, and combinations thereof.

8. The detergent composition of claim 7, wherein the alkyl ether sulfate is lauryl ether sulfate and the fatty acid is selected from a palm kernel fatty acid, a coconut fatty acid, and combinations thereof.

9. The detergent composition of claim 1, wherein the detergent composition further comprises at least one additive selected from an acid, an amino acid, a defoamer, a chlorine scavenger, an optical brightener, a fragrance, one or more enzymes, a corrosion inhibitor, and combinations thereof.

10. The detergent composition of claim 9, wherein the detergent composition further comprises an acid.

11. The detergent composition of claim 10, wherein the acid is citric acid.

12. The detergent composition of claim 1, wherein the composition is stable for four weeks at each temperature of 4° C., 24° C., 40° C. and 52° C.

13. A method of manufacturing the liquid detergent composition of claim 1 comprising:
a) creating a base of at least 50 wt % water;
b) adding the at least one non-ionic surfactant and mixing until the non-ionic surfactant is completely solubilized;
c) adding the first anionic surfactant and mixing until the first anionic surfactant is completely solubilized;
d) optionally adding a second anionic surfactant and mixing until the second anionic surfactant is completely solubilized;
e) adding a polymer and mixing until the polymer is completely solubilized;
f) adding a chelant and mixing until the chelant is completely solubilized;
g) reducing the temperature of the mixture obtained from steps a-f to below 30° C.;
h) adding acid and optionally adding a preservative; and
i) adding a remainder of water.

14. The method of claim 13, wherein the detergent composition has a Zein score of not more than about 1%.

15. The method of claim 13, wherein the chelant is MGDA.

16. The method of claim 13, wherein the non-ionic surfactant is a non-ionic alcohol ethoxylate.

17. The method of claim 16, wherein the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

18. The method of claim 13, wherein the second anionic surfactant is an alkyl ether sulfate.

19. The method of claim 13, wherein the first anionic surfactant is palm kernel fatty acid or a coconut fatty acid.

20. The composition of claim 1 comprising:
water;
about 15 to about 25 wt % of a combination of a non-ionic alcohol ethoxylate, a fatty acid, and an alkyl ether sulfate;
about 0.5 to about 5 wt % of a combination of an acrylic acid polymer and MGDA; and
citric acid.
